(19) United States
(12) Patent Application Publication
(10) Pub. No.: US 2005/0249148 A1
(43) Pub. Date: Nov. 10, 2005

(54) Measurement and reporting for uplink enhanced dedicated channel (E-DCH)

(75) Inventors: Masatoshi Nakamata, Espoo (FI); Karri Ranta-Aho, Espoo (FI); Antti Toskala, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/840,941

(22) Filed: May 7, 2004

(51) Int. Cl. H04Q 7/00; H04L 12/66

(52) U.S. Cl. 370/328; 370/352

(57) ABSTRACT

A base station (Node B) 12 provides information to a Radio Network Controller (RNC) 16 on how well User Equipment (UE) 14 subject to Node B scheduling is served for an Enhanced Dedicated Uplink Channel (E-DCH). This may be done for instance by the Node B measuring or estimating 22 the requested data rate per UE/cell, and communicating 24 the measured or estimated information to the RNC for enabling the RNC to perform Radio Resource Management (RRM). The RNC is thereby enabled to know the quality of the E-DCH transmission service per UE/cell. In addition to helping Admission Control and Load Control, it also enables the RNC to reconfigure the transport format combination set (TFCS) for E-DCH with more accurate timing. The UE and the Node B exchange information such as rate request/grant or UE Buffer and Transmit Power Status/Scheduling Assignment.

### BACKGROUND OF THE INVENTION

1. Technical Field

The invention relates to Universal Mobile Telecommunications System (UMTS) and, more particularly, to an enhanced uplink for UMTS Terrestrial Radio Access (UTRA) using Frequency Division Duplexing (FDD).

2. Discussion of Related Art

Work within the Third Generation Partnership Project (3GPP) to enhance UTRA uplink performance started in the autumn of 2002. Feasibility study work has recently been carried out under the 3GPP Release 6 study item “Uplink Enhancements for Dedicated Transport Channels.” This Enhanced Dedicated Uplink Channel (E-DCH) concept is a new feature under the specification work in 3GPP, with a work item started in March of 2004. There are some issues that have not been foreseen, are not yet realized as problems, and therefore are not covered by any solutions yet. One objective of the study item was to study methods for fast Node B based scheduling and this was set as one of the items to be specified within the work item. (“Node B” is comparable to the base station in second generation systems).

In the Enhanced Dedicated Channel (E-DCH) concept, uplink scheduling and rate control for an E-DCH Transport Channel resides in Node B whereas in the prior Release '99 (R'99) it resides in the RNC. Node B control of the Transport Format Combination (TFC) subset (“Node B controlled TFC subset”) includes plural TFCs from which the mobile station or User Equipment (UE) can select. The Node B informs the UE of the TFC subset. When the UE wants to change the TFC subset for increasing data rate, etc., the UE sends a request to the Node B and the Node B updates the TFC subset, considering radio resource in the Node B. The Radio Network Controller (RNC) can calculate the actual granted data rate from the amount of data RNC receives. But due to the involvement of the Node B, the RNC does not have to be involved as much in the scheduling. Hence an overall speedup is foreseen for E-DCH. However, given this scenario, the RNC does not have any method to know the actual data rate that the UE is requesting. Since the RNC cannot know whether the cell is fully loaded or whether new users can be allocated to maintain the QoS of the existing users, the RNC does not know when it should re-configure the Transport Format Combination Set (TFCS) for the E-DCH Transport Channel.

It should be noted that if the scheduled uplink transmission is not tied to the existing 3GPP Release 99 transmission scheme, the control of the transmission data rate may not necessarily be based on the different TFCs of a TFCS, and the present invention is not tied to the usage of TFC and TFCS for the control of the transmission data rate.

### DISCLOSURE OF INVENTION

According to a first aspect of the present invention, a method for use in a system having mobile stations in radio contact with a base station connected to a radio network controller, comprises the steps of measuring in the base station information on how well base station scheduled mobile stations are being served, and reporting the measured information on how well base station scheduled mobile stations are being served from the base station to the radio network controller.

In accord with the first aspect of the present invention, the measuring may comprise measuring a ratio of data rates actually used in transmitting data by the mobile stations to data rates the mobile stations would or could have used in transmitting data in case no restrictions were sent to them by the base station.

In further accord with the first aspect of the present invention, the information may comprise a measurement of how much the base station restricts mobile station transmission data rates from mobile station requested data rates.

In still further accord with the first aspect of the present invention, the measuring may comprise measuring a number of rate requests received by the base station from mobile stations and rate grants sent by the base station to the mobile stations.

Still further in accord with the first aspect of the present invention, for a given mobile station said measuring may comprise measuring an actual granted data rate for transmission to a data rate that a mobile station is requesting or can be considered to be requesting. For a given mobile station said data rate that a mobile station is requesting may be indicated by a transport format combination that the mobile station requests and said actual granted data rate for transmission may be indicated by a current maximum transport format combination for the mobile station. Or, said measuring may comprise Node B using signaling from a mobile station having information relating to buffer status of the mobile station and available transmission power.

According to a second aspect of the present invention, a method for use in a mobile station in a system having plural mobile stations in radio contact with a base station connected to a radio network controller, comprises the steps of transmitting from said mobile station to the base station information concerning a requested data rate or an indication of an acceptable data rate for use by said base station in reporting to said radio network controller how well base station scheduled mobile stations are being served, and receiving in said mobile station information from the base station concerning a data rate granted or an allowable data rate for said mobile station.

In accord with the second aspect of the present invention, said reporting indicates a ratio of data rates actually used in transmitting data by the mobile stations to the data rates the mobile stations would or could have used in transmitting data in case no restrictions were sent to them by the base station.

In further accord with the second aspect of the present invention, said reporting indicates how much the base station restricts mobile station transmission data rates from mobile station requested data rates.

In still further accord with the second aspect of the present invention, said reporting indicates a measurement of a number of rate requests received by the base station from mobile stations and rate grants sent by the base station to the mobile stations.

Still further in accord with the second aspect of the present invention, for a given mobile station said reporting is indicative of an actual granted data rate for transmission to a data rate that a mobile station is requesting or can be considered to be requesting.

According further to the second aspect of the present invention, wherein both said requested data rate and said data rate granted is for use by said base station in counting a number of rate requests received by the base station from said plural mobile stations and in counting rate grants sent by the base station to the mobile stations for said use by said base station in reporting to said radio network controller how well base station scheduled mobile stations are being served. The information concerning a requested data rate or an indication of an acceptable data rate may be provided as a mobile station buffer status and available power information by the mobile station.

According still further to the second aspect of the present invention, for said mobile station, said base station provides a measurement indicative of an actual granted data rate for transmission by said mobile station as compared to a data rate that said mobile station is requesting. For said mobile station said data rate that a mobile station is requesting may be indicated by a transport format combination indicator that the mobile station requests and said actual granted data rate for transmission may be indicated by a current maximum transport format combination indicator granted by the base station for the mobile station.

According to a third aspect of the present invention, a method for use in a radio network controller performing radio resource management functions in a system having plural mobile stations in radio contact with a base station connected to said radio network controller comprises the steps of obtaining information from said base station concerning how well base station scheduled mobile stations are being served, and using said information in said performing said radio resource management functions.

In further accord with the third aspect of the present invention, said information comprises a measurement of how much the base station restricts mobile station transmission data rates from mobile station requested data rates.

According to a fourth aspect of the present invention, a base station for use in a system having mobile stations in radio contact with said base station connected to a radio network controller comprises means for measuring in the base station information on how well base station scheduled mobile stations are being served, and means for reporting the measured information on how well base station scheduled mobile stations are being served from the base station to the radio network controller.

In further accord with the fourth aspect of the present invention, said reporting indicates a ratio of data rates actually used in transmitting data by the mobile stations to the data rates the mobile stations would or could have used in transmitting data in case no restrictions were sent to them by the base station.

Further in accord with the fourth aspect of the present invention, said reporting indicates how much the base station restricts mobile station transmission data rates from mobile station requested data rates.

In still further accord with the fourth aspect of the present invention, said reporting indicates a measurement of a number of rate requests received by the base station from mobile stations and rate grants sent by the base station to the mobile stations.

Still further in accord with the fourth aspect of the present invention, for a given mobile station said reporting is indicative of an actual granted data rate for transmission to a data rate that a mobile station is requesting or can be considered to be requesting.

Further in accord with the fourth aspect of the present invention, said information comprises a measurement of how much the base station restricts mobile station transmission data rates from mobile station requested data rates.

Further still in accord with the fourth aspect of the present invention, said means for measuring comprises means for measuring a number of rate requests received by the base station from mobile stations and rate grants sent by the base station to the mobile stations. Said means for measuring may comprise means for measuring mobile station buffer status and available power information from signaling provided by the mobile station.

Still further in accord with the fourth aspect of the present invention, for a given mobile station said means for measuring comprises means for measuring an actual granted data rate for transmission to a data rate that a mobile station is requesting. For a given mobile station said data rate that a mobile station is requesting may be indicated by a transport format combination indicator that the mobile station requests and said actual granted data rate for transmission may be indicated by a current maximum transport format combination indicator for the mobile station.

According to a fifth aspect of the present invention, a mobile station for use in a system having plural mobile stations in radio contact with a base station connected to a radio network controller, comprises means for transmitting from said mobile station to the base station information concerning a requested data rate or an indication of an acceptable data rate for use by said base station in reporting to said radio network controller how well base station scheduled mobile stations are being served, and means for receiving in said mobile station information from the base station concerning a data rate granted or an allowable data rate for said mobile station.

In further accord with the fifth aspect of the present invention, said reporting indicates a ratio of data rates actually used in transmitting data by the mobile stations to the data rates the mobile stations would or could have used in transmitting data in case no restrictions were sent to them by the base station.

In still further accord with the fifth aspect of the present invention, wherein said reporting indicates how much the base station restricts mobile station transmission data rates from mobile station requested data rates.

Still further in accord with the fifth aspect of the present invention, said reporting indicates a measurement of a number of rate requests received by the base station from mobile stations and rate grants sent by the base station to the mobile stations.

According still further to the fifth aspect of the present invention, for a given mobile station said reporting is indicative of an actual granted data rate for transmission to a data rate that a mobile station is requesting or can be considered to be requesting.

In further accordance with the fifth aspect of the present invention, both said requested data rate and said data rate granted are for use by said base station in counting a number of rate requests received by the base station from said plural mobile stations and in counting rate grants sent by the base station to the mobile stations for said use by said base station in reporting to said radio network controller how well base station scheduled mobile stations are being served.

In still further accordance with the fifth aspect of the present invention, for said mobile station, said base station provides a measurement indicative of an actual granted data rate for transmission by said mobile station as compared to a data rate that said mobile station is requesting. Said data rate said mobile station is requesting may be indicated by a transport format combination indicator that the mobile station requests and said actual granted data rate for transmission may be indicated by a current maximum transport format combination indicator granted by the base station for the mobile station. The information concerning a requested data rate or an indication of an acceptable data rate may be provided by the mobile station as a mobile station buffer status and available power information.

According to a sixth aspect of the present invention, a system, comprises a radio network controller performing radio resource management functions in said system having plural mobile stations in radio contact with a base station connected to said radio network controller, said radio network controller for obtaining or receiving information from said base station concerning how well base station scheduled mobile stations are being served, and for using said information in said performing said radio resource management functions.

According to a seventh aspect of the present invention, a computer program stored on a computer readable medium is provided for carrying out steps according to the first aspect of the invention.

According to an eighth aspect of the present invention, a computer program stored on a computer readable medium is provided for carrying out the second aspect of the invention.

According to a ninth aspect of the present invention, a computer program stored on a computer readable medium is provided for carrying out the third aspect of the invention.

The present invention advantageously enables the RNC to know the quality of E-DCH transmission service per UE/cell. It helps Admission Control in addition to Load Control. It also enables the RNC to reconfigure the TFCS for E-DCH with more accurate timing

These and other objects, features and advantages of the present invention will become more apparent in light of the following detailed description of a best mode embodiment thereof, as illustrated in the accompanying drawing.

### BRIEF DESCRIPTION OF THE DRAWINGS

FIG. 1 shows a system comprising a radio network controller connected to a base station (e.g., Node B) in radio contact with plural mobile stations (e.g., user equipment), according to the present invention.

FIG. 2 is a flow chart showing a method for use in a base station (Node B) connected to a radio network controller (RNC) in a system having plural mobile stations in radio contact with the Node B, according to the present invention, and which method may be embodied in a computer program readable by a computer or embodied by circuitry on a computer chip.

FIG. 3 shows a base station (e.g., a so-called Node B of the third generation) and the various components residing therein in cooperative relationship, according to the present invention.

FIG. 4 shows a mobile station (e.g., a so-called user equipment of the third generation) and the various components residing therein in cooperative relationship, according to the present invention.

FIG. 5 shows a method for use in a mobile station (e.g., UE) in radio contact with a base station (e.g., Node B) in a system having plural mobile stations in radio contact with the base station, according to the present invention, and which method may be embodied in a computer program readable by a computer or embodied by circuitry on a computer chip.

FIG. 6 shows a method for use in a radio network controller (RNC) connected to a base station (e.g., Node B) in a system having plural mobile stations (e.g., third generation UEs) in radio contact with the base station, according to the present invention, and which method may be embodied in a computer program readable by a computer or embodied by circuitry on a computer chip.

FIG. 7 shows a radio network controller (RNC) and the various components residing therein in cooperative relationship, according to the present invention.

### BEST MODE FOR CARRYING OUT THE INVENTION

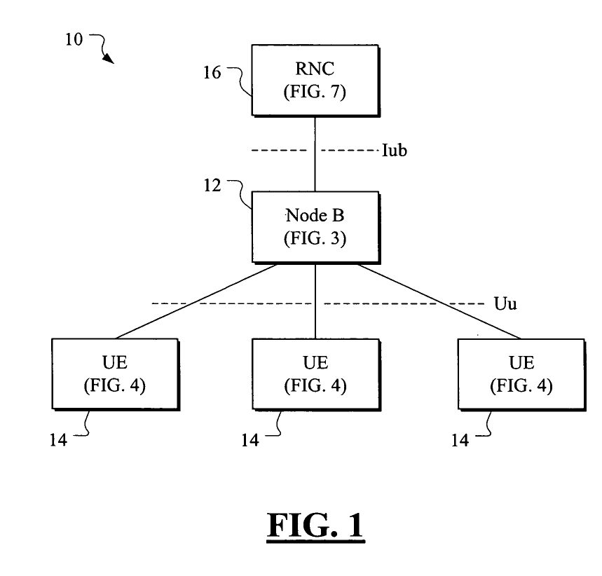

FIG. 1 shows a system 10, according to the present invention, that is able to use base station (Node B) 12 uplink scheduling of an enhanced dedicated channel (E-DCH) for plural mobile stations 14 under the general radio resource management (RRM) of a radio network controller (RNC) 16. A “Feasibility Study for Enhanced Uplink for UTRA FDD (Release 6)” is described in 3GPP TR 25.896 v6.0.0 (2004-03). Although not illustrated in FIG. 1, an RNC 16 may have more than one Node B 12 connected thereto.

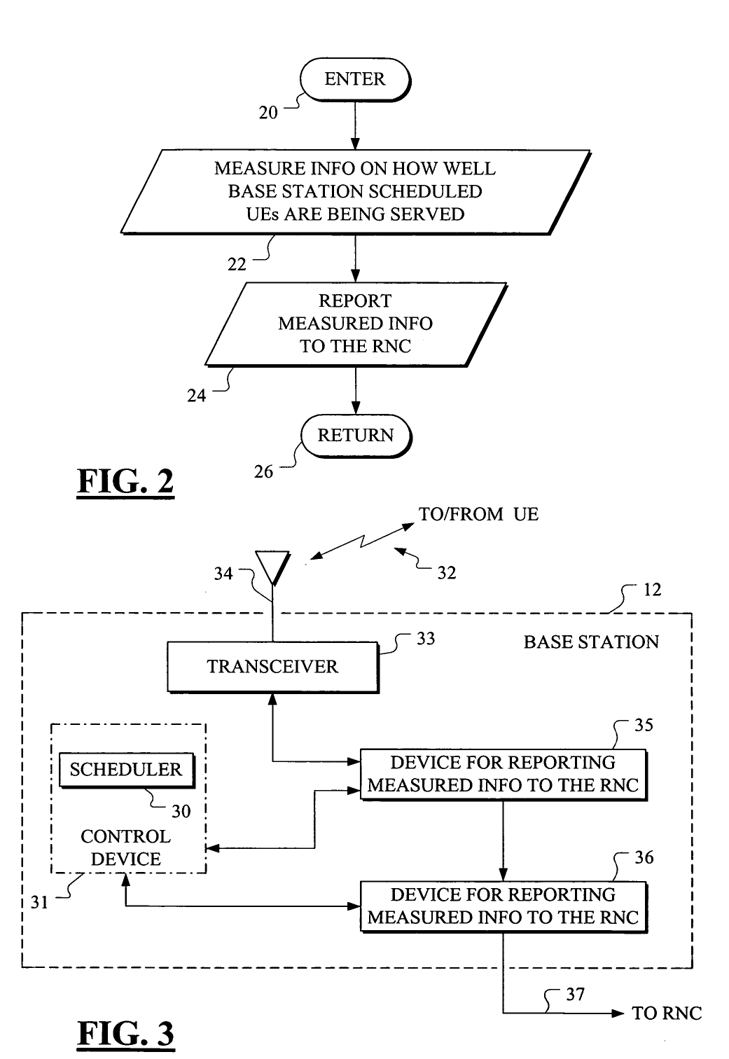

The Node B 12 of FIG. 1 is shown in more detail in FIG. 3 and a method carried out therein is shown in FIG. 2.

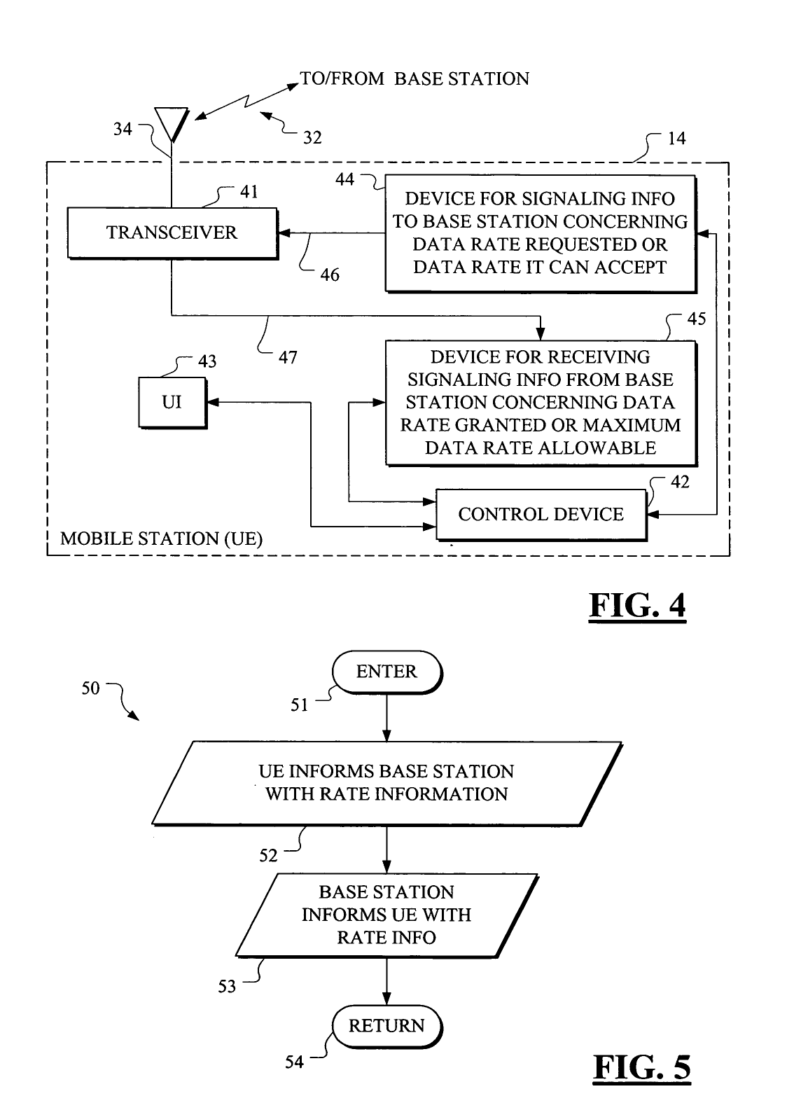

The mobile station (called “user equipment” in the 3GPP) 14 is shown in more detail in FIG. 4 and a method carried out therein is shown in the flow chart of FIG. 5.

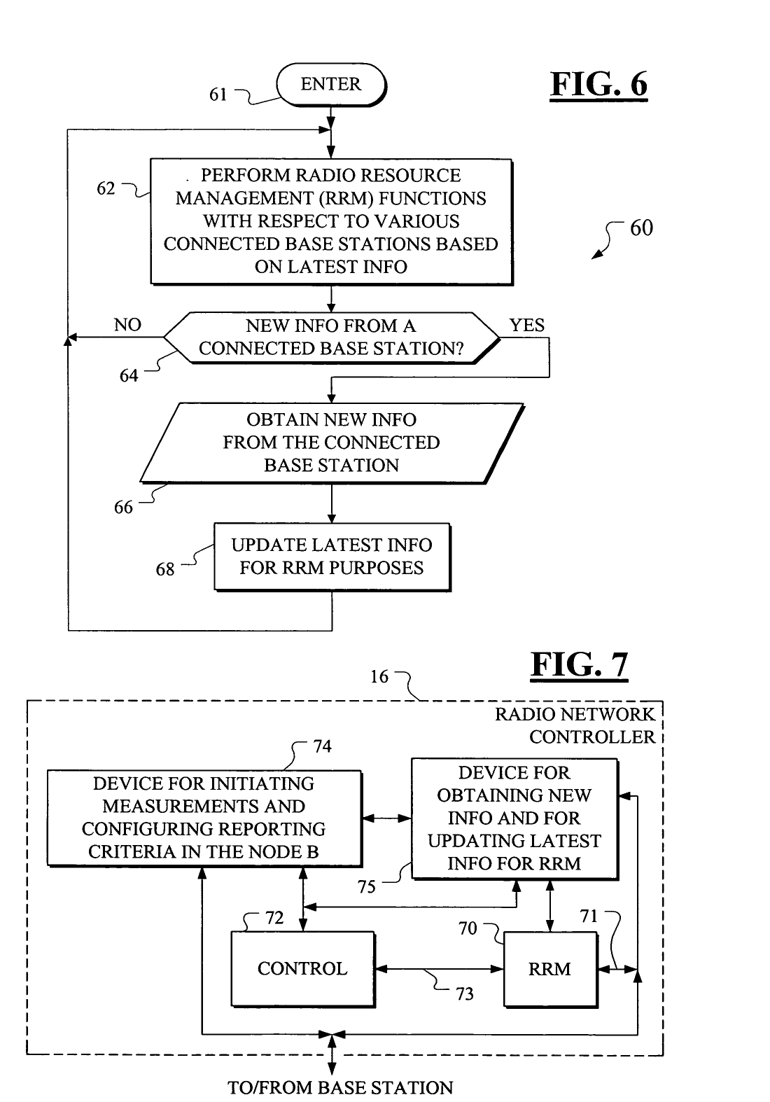

The radio network controller is shown in more detail in FIG. 7 and a method for carrying out the present invention therein is illustrated in FIG. 6.

The basic crystallization of the invention is for the base station (e.g., Node B in the 3GPP) to provide information to the radio network controller (RNC) on how well the users subject to the uplink Node B scheduling are served (Node B scheduling for E-DCH is currently under standardization in 3GPP). Therefore, according to the present invention, the base station 12 of FIGS. 1 and 3 provides information to the radio network controller (RNC) on how well user equipment subject to base station (Node B) scheduling is served for an enhanced dedicated uplink channel (E-DCH) according for example to the methodology shown in FIG. 2. This may be done for instance by the base station (Node B) measuring or estimating the requested data rate per UE/cell, and communicating the measured or estimated information to the RNC 16 for enabling the RNC to perform radio resource management (RRM). The RNC 16 is thereby enabled to know the quality of the E-DCH transmission service per UE/cell. It helps Admission Control in addition to Load Control. It also enables the RNC 16 to reconfigure the Transport Format Combination Set (TFCS) for E-DCH with more accurate timing. The mobile station (UE) 14 and the base station (Node B) 12 exchange information such as rate request/grant or UE Buffer and Transmit Power Status/Scheduling Assignment.

At the moment the Fast Node B controlled uplink scheduling is being standardized in 3GPP within an FDD Enhanced Uplink work item. A scheduler 30 can be viewed as part of a control device 31 shown in the base station (Node B) 12 of FIG. 3. The exact scheduling related information that a UE 14 sends to the base station (Node B) 12 as well as the information the base station (Node B) 12 sends to the UE 14 are at the moment subject to discussion and yet undecided. All the proposals under discussion so far can be generalized to:
the UE sends the Node B information to help the Node B scheduler know what data rates the UE could use, and
The Node B sends the UE information related to the data rate the UE is allowed to use, potentially including information on how long this information can be considered to be valid for the UE.

The Node B scheduler's task is to distribute the uplink capacity (not being used by the traffic not subject to the Node B scheduling) to the UEs that are subject to Node B scheduling. In the case that the offered uplink capacity to the cell is below the maximum allowable loading in the radio uplink, the Node B scheduler's task is simple, it can just grant whatever each user is requesting, subject to the amount of traffic (capacity consumption) offered. In the case that the offered traffic would exceed the maximum allowable uplink loading, the Node B scheduler makes sure that the uplink is not overloaded by not allowing all the users to get the data rates that they would like to use. In effect the Node B scheduler works as a fast load controller.

The basic load control function (interacting e.g. with admission control and packet scheduler) resides in the RNC and the primary information for the RNC load controller is the measured uplink loading. Similarly, the RNC's admission control and packet scheduling functionalities evaluate what kind of new traffic can be allowed to the cell based on the Node B provided uplink load measurements. Introducing the Node B scheduler (being in effect a load control function in the Node B) the traditional uplink load measurement, Received Total Wideband Power (RTWP is defined in 3GPP R'99 WCDMA specifications) is not anymore providing the RNC with a full picture of the uplink loading.

In the case that the RTWP measurement would indicate that the uplink is fully loaded the RNC would typically not allow new users in the cell and it could start reducing the allowable data rates of the existing users.

With the Fast Node B Controlled Uplink Scheduling, we can consider two cases of a fully loaded uplink:
1. There is traffic under the Node B scheduler's control in the cell and the users are being served well, i.e. they are typically getting the data rates they are requesting. In this case the RNC call admission control could allow e.g. new voice users or new Node B scheduler users to the cell with the increased possibility of detrimental effects on the QoS experienced by the existing plus potential new Node B scheduled users. The Node B scheduler would just make sure that the uplink stays fully loaded but never gets overloaded. The point is merely that when we allow more users to the cell the probability that sometimes some of them do not experience the same data throughput any more and thus user experience may degrade to some extent. The QoS system enables us to allow e.g. more voice calls in the cell and slightly reduce the average uplink data rates of the internet browsers etc. thus maintaining the same uplink cell loading.
2. There is traffic under the Node B scheduler control in the cell and the users are being served poorly, i.e. they are typically getting the data rates clearly below what they are requesting and possibly some users are not scheduled at all. In this case the RNC call admission control would know that the Node B scheduled users are already experiencing bad QoS and if new users are allowed to the cell, the QoS of the Node B scheduled users would further degrade and the cell would risk getting overloaded. In some cases, even by stopping all the Node B controlled traffic, the experienced uplink loading would not be reduced enough.

Now, this information on how well the Node B scheduled users are being served is essential for making the difference in the above cases. The present standardization efforts do not recognize this fact. The present invention solves this problem by measuring (in the Node B) and reporting (from Node B) that information to the RNC.

FIG. 2 shows a flowchart carried out in the base station (Node B) 12 of FIGS. 1 and 3. After entering in a step 20, a step 22 is carried out to measure information on how well base station scheduled mobile stations (UE) 14 are being served. Once this measurement is made, it is reported in a step 24 to the RNC 16.

FIG. 3 shows the base station 12 of FIG. 1 in more detail and illustrates a radio link 32 between the base station 12 and a mobile station (UE) 14. A transceiver 33 sends a radio downlink from an antenna 34 and receives a radio uplink from the antenna. It is connected to a device 35 for carrying out the measurement step 22 of FIG. 2. Another device 36 receives the measurement from the measuring device 35 and reports the result on a signal line 37 to the RNC 16.

FIG. 4 shows a mobile station (UE) 14 having an antenna 40 connected to a transceiver 41 for sending and receiving information to and from the base station (Node B) 12 of FIGS. 1 and 3. A control device 42 controls various modules and devices within the mobile station (UE) 14 including a user interface 43, a device 44 and a device 45. The device 44 is for providing information on a signal line 46 to the transceiver 41 concerning a data rate requested by the mobile station 14 or a data rate it can accept for transmission by the antenna 40 on the radio link 32 to the base station 12. The device 45 is for receiving a signal on a line 47 from the transceiver 41 having information from the base station (UE) 14 concerning a data rate granted or a maximum data rate allowable. This information is used by the control device 42 in operating the mobile station (UE) 14.

FIG. 5 shows a method 50 that may be carried out in the mobile station (UE) 14 of FIG. 4, according to the present invention. After entering in a step 51, a step 52 is executed wherein the mobile station (UE) 14 informs the base station of rate information such as described previously by means of the device 44 of FIG. 4. In response, the base station informs the mobile station (UJE) with rate information and the information is received, for example by the device 45 of FIG. 4, as shown in a step 53. A return is then made in a step 54.

As the exact information the UE and the Node B are going to exchange are not yet specified, the exact implementation of the measurement is difficult to describe at the moment but the present specification describes a few possibilities on how it could be done.

Rate Request/Rate Grant

In this implementation of the Node B scheduling, the UE sends in the uplink a single bit indication with which it can make a request for a higher data rate if needed. (There is no need to request for a lower data rate as the UE is all the time allowed to use data rates below maximum). The Node B respectively can command the UE either to increase or decrease its maximum allowed data rate (or let it remain as it was). These messages are referred as Rate Request (RR) and Rate Grant (RG)

UE Buffer & Tx Power status/Scheduling Assignment

In this implementation of the Node B scheduling, the UE informs the Node B with the amount of data it has in its buffer with the available Tx power headroom. From this information the Node B scheduler can derive the maximum data rate the UE could use (as well as how long it could use it). (Alternatively, the UE could signal directly the maximum data rate it could use.) The Node B sends in the downlink a Scheduling Assignment (SA) with which the Node B tells the UE the maximum data rate the UE is allowed to use (and possibly how long it is allowed to transmit with it).

Alternatively any uplink/downlink scheduling signaling combination could as well be a feasible option and the present invention is not tied to any particular scheduling signaling but can be applied to Node B uplink scheduling regardless of the information being exchanged by the Node B and the UE.

The Measurement

Requested Data Rate Measurement can provide the RNC an average ratio of
1. The number of RGs Node B sent to the number of RRs Node B received (for indicating how much Node B satisfies UE's requests), or
2. Actual granted data rate for E-DCH transmission to data rate that UE can be considered requesting by L1 signaling.

The measurement can be applied per UE (i.e. Dedicated Measurement) as well as per scheduling priority (i.e. Common Measurement).

Node B executes the measurement based on feedback from the UE (the exact feedback from UE to Node B is currently open in 3GPP).

In more detail, the measurement could be carried out as follows:

1. The number of the Rate Requests (RR) Node B receives and Rate Grants (RG) Node B sends. The formula is as below.

$$M = \frac{Y}{X}$$

M: Measurement result
Y: the number of RG=ups Node B sent for the UE/the Scheduling Priority
X: the number of RR=ups Node B received for the UE/the Scheduling Priority

The formula could be extended to take into account the number of RG=down commands forcing the UE to reduce its transmission data rate.

2-1. The Transport Format Combination (TFC) (i.e. the transmission data rate) that the UE requests and the current max TFC (i.e. the current maximum allowed data rate) for the UE. The formula could be e.g. as shown below.

$$M = \frac{{\sum }_{i = 1}^{j} Yi}{{\sum }_{i = 1}^{j} Xi}$$

M: Measurement result
Xi: average of requested data rates of UE i
Yi: average of granted rate for UE i

2-2. UE Buffer Status and available power information signaled by the UE The idea is that the UE informs the Node B with how much data it has in its buffer (to let the Node B understand what kind of data rate would be sensible for the UE) and its maximum transmission power (this translates directly to the maximum data rate the UE is capable of transmitting as the higher the data rate the more power is needed and there is a limit for the power the UE is capable of transmitting). Thus from the power headroom the Node B knows the maximum data rate the UE is capable of transmitting and from the buffer status the Node B knows what kind of data rate would be sensible for the UE. This can be translated to a requested data rate. This translation could as well take place in the UE and be signaled to the Node B as a data rate request instead of the two metrics

Node B then signals the measurement report to the RNC using the same mechanisms as currently specified for the existing measurements. The RNC can use the measurement report for Radio Resource Management (RRM) purposes. In the specifications only the measurement will be specified, not the exact way of using it in the RNC.

FIG. 6 shows a method 60 that may be carried out in a radio network controller (RNC) 16 such as shown in FIGS. 1 and 7, according to the present invention. After entering in a step 61, a step 62 is executed to perform radio resource management functions more or less continuously with respect to various connected base stations and based on the very latest feedback from these base stations and by extension from the mobile stations 14 to which they are linked by a radio interface (Uu) shown in FIG. 1. If new information becomes available from a connected base station (Node B) 12 as determined in a step 64, the new information is obtained in a step 66 and the prior information stored in the RNC 16 is updated for purposes of RRM and the step 62 is executed again but this time using the updated information. If the step 64 determines there is no new information from a connected base station (Node B), the RRM step 62 is re-executed forthwith, without any updating.

The RNC 16 illustrated in FIG. 7 is equipped with various devices to facilitate the operation of the method 60 of FIG. 6. It includes a Radio Resource Control module 70 with which it carries out its normal RRM functionalities subject to updating on a signal line 71 by its connected base stations (Node Bs) 12. For instance, the RRM 70 may include an Admission Control function as well as a Load Control function (not shown). A control 72 controls the RRM module 70 over a control signal line 73. A device 74 is able to send signaling to the Node B to initiate measurements in the Node B and to configure reporting criteria received by the RNC in reports from the Node B, e.g., the Node B is instructed to report periodically or to report if the measurement results exceed a certain value or change by a certain amount, etc. A device 75 obtains the new information for the RNC 16 from the connected base stations (Node Bs) 12 and provides it to the RRM 70. The device 75 updates the RRM's current information with the very latest information. The control device 72 coordinates the initiation, configuration process, the process of obtaining and the updating process in the RNC's RRM as illustrated by interconnected control lines between the various devices and the control 72. The receipt and updating of the latest information available from the base stations (Node Bs), according to the present invention, advantageously enables the RNC to know the quality of E-DCH transmission service per UE/cell. It helps Admission Control in addition to Load Control. It also enables the RNC to reconfigure the TFCS for E-DCH with more accurate timing.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Method for use in a system having mobile stations in radio contact with a base station connected to a radio network controller, comprising the steps of:
measuring in the base station information on how well base station scheduled mobile stations are being served, and
reporting the measured information on how well base station scheduled mobile stations are being served from the base station to the radio network controller.

2. The method of claim 1, wherein said measuring comprises measuring a ratio of data rates actually used in transmitting data by the mobile stations to data rates the mobile stations would or could have used in transmitting data in case no restrictions were sent to them by the base station.

3. The method of claim 1, wherein said information comprises a measurement of how much the base station restricts mobile station transmission data rates from mobile station requested data rates.

4. The method of claim 1, wherein said measuring comprises measuring a number of rate requests received by the base station from mobile stations and rate grants sent by the base station to the mobile stations.

5. The method of claim 1, wherein for a given mobile station said measuring comprises measuring an actual granted data rate for transmission to a data rate that a mobile station is requesting or can be considered to be requesting.

6. The method of claim 5, wherein for a given mobile station said data rate that a mobile station is requesting is indicated by a transport format combination that the mobile station requests and said actual granted data rate for transmission is indicated by a current maximum transport format combination for the mobile station.

7. The method of claim 5, wherein said measuring comprises Node B using signaling from a mobile station having information relating to buffer status of the mobile station and available transmission power.

8. Method for use in a mobile station in a system having plural mobile stations in radio contact with a base station connected to a radio network controller, comprising the steps of:
transmitting from said mobile station to the base station information concerning a requested data rate or an indication of an acceptable data rate for use by said base station in reporting to said radio network controller how well base station scheduled mobile stations are being served, and
receiving in said mobile station information from the base station concerning a data rate granted or an allowable data rate for said mobile station.

9. The method of claim 8, wherein said reporting indicates a ratio of data rates actually used in transmitting data by the mobile stations to the data rates the mobile stations would or could have used in transmitting data in case no restrictions were sent to them by the base station.

10. The method of claim 8, wherein said reporting indicates how much the base station restricts mobile station transmission data rates from mobile station requested data rates.

11. The method of claim 8, wherein said reporting indicates a measurement of a number of rate requests received by the base station from mobile stations and rate grants sent by the base station to the mobile stations.

12. The method of claim 8, wherein for a given mobile station said reporting is indicative of an actual granted data rate for transmission to a data rate that a mobile station is requesting or can be considered to be requesting.

13. The method of claim 8, wherein both said requested data rate and said data rate granted is for use by said base station in counting a number of rate requests received by the base station from said plural mobile stations and in counting rate grants sent by the base station to the mobile stations for said use by said base station in reporting to said radio network controller how well base station scheduled mobile stations are being served.

14. The method of claim 8, wherein for said mobile station, said base station provides a measurement indicative of an actual granted data rate for transmission by said mobile station as compared to a data rate that said mobile station is requesting.

15. The method of claim 14, wherein for said mobile station said data rate that a mobile station is requesting is indicated by a transport format combination indicator that the mobile station requests and said actual granted data rate for transmission is indicated by a current maximum transport format combination indicator granted by the base station for the mobile station.

16. The method of claim 13, wherein said information concerning a requested data rate or an indication of an acceptable data rate is provided as a mobile station buffer status and available power information by the mobile station.

17. Method for use in a radio network controller performing radio resource management functions in a system having plural mobile stations in radio contact with a base station connected to said radio network controller, comprising the steps of:
obtaining information from said base station concerning how well base station scheduled mobile stations are being served, and
using said information in said performing said radio resource management functions.

18. The method of claim 17, wherein said information comprises a measurement of how much the base station restricts mobile station transmission data rates from mobile station requested data rates.

19. Base station for use in a system having mobile stations in radio contact with said base station connected to a radio network controller, comprising:
means for measuring in the base station information on how well base station scheduled mobile stations are being served, and
means for reporting the measured information on how well base station scheduled mobile stations are being served from the base station to the radio network controller.

20. The base station of claim 19, wherein said reporting indicates a ratio of data rates actually used in transmitting data by the mobile stations to the data rates the mobile stations would or could have used in transmitting data in case no restrictions were sent to them by the base station.

21. The base station of claim 19, wherein said reporting indicates how much the base station restricts mobile station transmission data rates from mobile station requested data rates.

22. The base station of claim 19, wherein said reporting indicates a measurement of a number of rate requests received by the base station from mobile stations and rate grants sent by the base station to the mobile stations.

23. The base station of claim 19, wherein for a given mobile station said reporting is indicative of an actual granted data rate for transmission to a data rate that a mobile station is requesting or can be considered to be requesting.

24. The base station of claim 19, wherein said information comprises a measurement of how much the base station restricts mobile station transmission data rates from mobile station requested data rates.

25. The base station of claim 19, wherein said means for measuring comprises means for measuring a number of rate requests received by the base station from mobile stations and rate grants sent by the base station to the mobile stations.

26. The base station of claim 19, wherein for a given mobile station said means for measuring comprises means for measuring an actual granted data rate for transmission to a data rate that a mobile station is requesting.

27. The base station of claim 26, wherein for a given mobile station said data rate that a mobile station is requesting is indicated by a transport format combination indicator that the mobile station requests and said actual granted data rate for transmission is indicated by a current maximum transport format combination indicator for the mobile station.

28. The base station of claim 25, wherein said means for measuring comprises means for measuring mobile station buffer status and available power information from signaling provided by the mobile station.

29. Mobile station for use in a system having plural mobile stations in radio contact with a base station connected to a radio network controller, comprising:
means for transmitting from said mobile station to the base station information concerning a requested data rate or an indication of an acceptable data rate for use by said base station in reporting to said radio network controller how well base station scheduled mobile stations are being served, and
means for receiving in said mobile station information from the base station concerning a data rate granted or an allowable data rate for said mobile station.

30. The mobile station of claim 29, wherein said reporting indicates a ratio of data rates actually used in transmitting data by the mobile stations to the data rates the mobile stations would or could have used in transmitting data in case no restrictions were sent to them by the base station.

31. The mobile station of claim 29, wherein said reporting indicates how much the base station restricts mobile station transmission data rates from mobile station requested data rates.

32. The mobile station of claim 29, wherein said reporting indicates a measurement of a number of rate requests received by the base station from mobile stations and rate grants sent by the base station to the mobile stations.

33. The mobile station of claim 29, wherein for a given mobile station said reporting is indicative of an actual granted data rate for transmission to a data rate that a mobile station is requesting or can be considered to be requesting.

34. The mobile station of claim 29, wherein both said requested data rate and said data rate granted are for use by said base station in counting a number of rate requests received by the base station from said plural mobile stations and in counting rate grants sent by the base station to the mobile stations for said use by said base station in reporting to said radio network controller how well base station scheduled mobile stations are being served.

35. The mobile station of claim 29, wherein for said mobile station, said base station provides a measurement indicative of an actual granted data rate for transmission by said mobile station as compared to a data rate that said mobile station is requesting.

36. The mobile station of claim 35, wherein for said mobile station said data rate that a mobile station is requesting is indicated by a transport format combination indicator that the mobile station requests and said actual granted data rate for transmission is indicated by a current maximum transport format combination indicator granted by the base station for the mobile station.

37. The mobile station of claim 34, wherein said information concerning a requested data rate or an indication of an acceptable data rate is provided by the mobile station as a mobile station buffer status and available power information.

38. System, comprising:
a radio network controller performing radio resource management functions in said system having
plural mobile stations in radio contact with
a base station connected to said radio network controller,
said radio network controller for obtaining or receiving information from said base station concerning how well base station scheduled mobile stations are being served, and for using said information in said performing said radio resource management functions.

39. A computer program stored on a computer readable medium for carrying out the steps of claim 1.

40. A computer program stored on a computer readable medium for carrying out the steps of claim 8.

41. A computer program stored on a computer readable medium for carrying out the steps of claim 17.
